(19) United States
(12) Patent Application Publication
(10) Pub. No.: US 2007/0263321 A1
(43) Pub. Date: Nov. 15, 2007

(54) System and method for integrated spindle balance and contamination control for disk drives

(76) Inventors: Andre S. Chan, Milpitas, CA (US); Robert A. Lenicheck, Palo Alto, CA (US); Jr-Yi Shen, Sunnyvale, CA (US); Mike Tatarakis, San Jose, CA (US)

Correspondence Address: WAGNER, MURABITO & HAO LLP, Third Floor, Two North Market Street, San Jose, CA, 95113, US

(21) Appl. No.: 11/431,443

(22) Filed: May 9, 2006

(51) Int. Cl. G11B 17/02

(52) U.S. Cl. 360/99.12

(57) ABSTRACT

A disk drive comprising a combination disk drive counterbalance and disk clamp seal is provided. The disk drive comprises a spindle for rotating a disk, the spindle comprising a hub. The disk drive further comprises a disk clamp for clamping the disk to the hub and a clamp seal coupled to the disk clamp for sealing the disk clamp from contamination wherein the clamp seal comprises a counter balance weight for balancing rotation of the disk.

### TECHNICAL FIELD

This invention relates to the field of hard disk drives, and more particularly to an integrated method and system for balancing a spindle and controlling contamination.

### BACKGROUND ART

Hard disk drives are used in almost all computer system operations. In fact, most computing systems are not operational without some type of hard disk drive to store the most basic computing information such as the boot operation, the operating system, the applications, and the like. In general, the hard disk drive is a device which may or may not be removable, but without which the computing system will generally not operate.

The basic hard disk drive model includes a storage disk or hard disk that spins at a designed rotational speed. An actuator arm is utilized to reach out over the disk. The arm carries a head assembly that has a magnetic read/write transducer or head for reading/writing information to or from a location on the disk. The transducer is attached to a slider, such as an air-bearing slider, which is supported adjacent to the data surface of the disk by a cushion of air generated by the rotating disk. The transducer can also be attached to a contact-recording type slider. In either case, the slider is connected to the actuator arm by means of a suspension. The complete head assembly, e.g., the suspension and head, is called a head gimbal assembly (HGA).

In operation, the hard disk is rotated at a set speed via a spindle motor assembly having a central drive hub. Additionally, there are tracks evenly spaced at known intervals across the disk. When a request for a read of a specific portion or track is received, the hard disk aligns the head, via the arm, over the specific track location and the head reads the information from the disk. In the same manner, when a request for a write of a specific portion or track is received, the hard disk aligns the head, via the arm, over the specific track location and the head writes the information to the disk.

Over the years, the disk and the head have undergone great reductions in their size. Much of the refinement has been driven by consumer demand for smaller and more portable hard drives such as those used in personal digital assistants (PDAs), MP3 players, and the like. For example, the original hard disk drive had a disk diameter of 24 inches. Modem hard disk drives are much smaller and include disk diameters of less than 2.5 inches (micro drives are significantly smaller than that). Advances in magnetic recording are also primary reasons for the reduction in size.

This continual reduction in size has placed steadily increasing demands on the technology used in the HGA, particularly in terms of power consumption, shock performance, and disk real estate utilization. One recent advance in technology has been the development of the Femto slider, which is roughly one-third of the size and mass of the older Pico slider, which it replaces; over the past 23 years, slider size has been reduced by a factor of five, and mass by a factor of nearly 100.

These smaller sliders have substantially smaller surface areas, which increases the difficulties associated with achieving and maintaining a suitable fly height. Additionally, several of the applications for Femto sliders call for smaller disks, to better fit in portable electronic devices, and lower rotational speeds, to better conserve power. Moreover, with reduced flying heights, contact between the slider and disk surface becomes unavoidable. Coupled with concerns for slider damping in and out of contact with the disk surface, it has proven very difficult to find an appropriate design for the air bearing surface that meets the needs imposed by current demand.

Balancing of rotating parts is a great concern as well as contamination inside the drive itself. Conventionally, separate components are used to balance a disk drive spindle and control contamination of the disk drive assembly.

### SUMMARY

A disk drive comprising a combination disk drive counterbalance and disk clamp seal is provided. The disk drive comprises a spindle for rotating a disk, the spindle comprising a hub. The disk drive further comprises a disk clamp for clamping the disk to the hub and a clamp seal coupled to the disk clamp for sealing the disk clamp from contamination wherein the clamp seal comprises a counter balance weight for balancing rotation of the disk.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a plan view of an HDD with cover and top magnet removed in accordance with one embodiment of the present invention.

FIG. 2 is an illustration of an exemplary disk clamp seal comprising a counterbalance weight in accordance with embodiments of the present invention.

FIG. 3 is a side view illustration of an exemplary disk drive stack assembly comprising a clamp seal with an integrated counterbalance weight in accordance with embodiments of the present invention.

FIG. 4 is a flow diagram of an exemplary method for manufacture of a disk drive comprising a clamp seal with an integrated counterbalance in accordance with embodiments of the present invention.

FIG. 5 is a flow diagram of an exemplary method for manufacture of a disk drive including rotating a disk drive assembly to determine an imbalance and an associated counterbalance in accordance with embodiments of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

Embodiments of the present invention provide a disk clamp comprising a counter balance weight. The combination counterbalance weight and clamp seal can be coupled simultaneously to the disk drive assembly, which eliminates at least one processing step during disk drive assembly. Conventionally separate steps were required for sealing a disk clamp and balancing a disk drive assembly.

Particularly, embodiments of the present invention include a disk drive comprising a combination disk drive counterbalance and disk clamp seal is provided. The disk drive comprises a spindle for rotating a disk, the spindle comprising a hub. The disk drive further comprises a disk clamp for clamping the disk to the hub and a clamp seal coupled to the disk clamp for sealing the disk clamp from contamination wherein the clamp seal comprises a counter balance weight for balancing rotation of the disk.

Embodiments of the present invention further include a method for manufacturing a disk drive comprising placing a disk onto a hub of a spindle assembly and clamping the disk to the hub with a disk clamp. The method further includes sealing and balancing the spindle assembly by placing a clamp seal over the disk clamp, wherein the clamp seal comprises a counter balance weight.

Embodiments of the present invention further include a method for balancing a disk drive comprising rotating a disk drive assembly, determining an imbalance associated with the disk drive assembly, determining a counterbalance weight for balancing said imbalance, and coupling a clamp seal to the disk drive assembly, the clamp seal for controlling contamination of the disk drive assembly and the clamp seal comprising the counter balance weight for balancing the disk drive assembly.

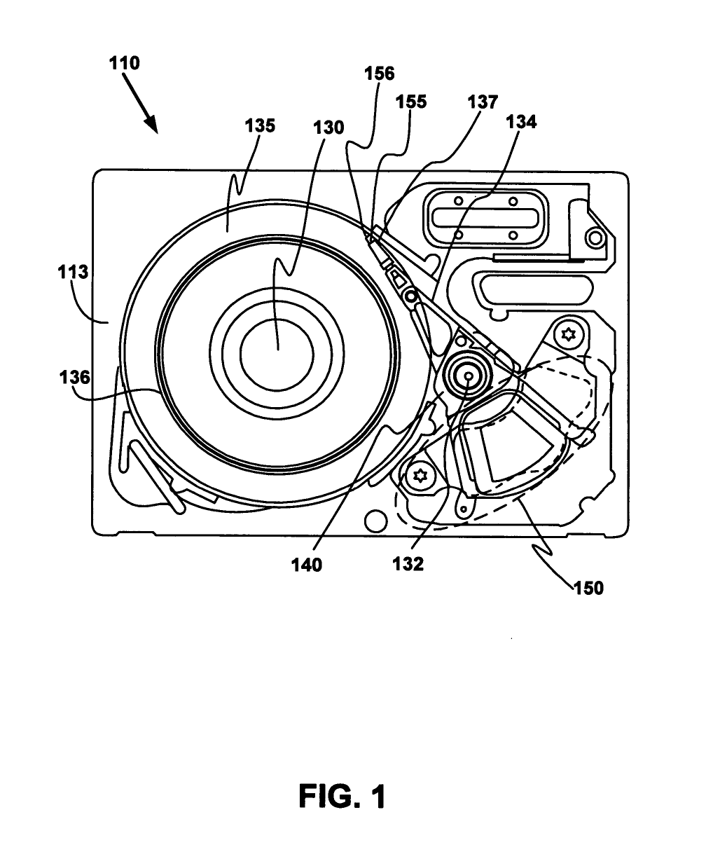

With reference now to FIG. 1, a plan view of an HDD with cover and top magnet removed is shown in accordance with one embodiment of the present invention. FIG. 1 illustrates the relationship of components and sub-assemblies of HDD 110 and a representation of data tracks 136 recorded on the disk surfaces 135 (one shown). The cover is removed and not shown so that the inside of HDD 110 is visible. The components are assembled into base casting 113, which provides attachment and registration points for components and sub-assemblies.

A plurality of suspension assemblies 137 (one shown) are attached to the actuator arms 134 (one shown) in the form of a comb. A plurality of transducer heads or sliders 155 (one shown) are attached respectively to the suspension assemblies 137. Sliders 155 are located proximate to the disk surfaces 135 for reading and writing data with magnetic heads 156 (one shown). The rotary voice coil motor 150 rotates actuator arms 134 about the actuator shaft 132 in order to move the suspension assemblies 150 to the desired radial position on the disk. The actuator shaft 132, hub 140, actuator arms 134, and voice coil motor 150 may be referred to collectively as a rotary actuator assembly.

Data is recorded onto disk surfaces 135 in a pattern of concentric rings known as data tracks 136. Disk surface 135 is spun at high speed by means of a motor-hub assembly 130. Data tracks 136 are recorded onto spinning disk surfaces 135 by means of magnetic heads 156, which typically reside at the end of sliders 155. FIG. 1 being a plan view shows only one head, slider, and disk surface combination. One skilled in the art understands that what is described for one head-disk combination applies to multiple head-disk combinations, such as disk stacks (not shown). However, for purposes of brevity and clarity, FIG. 1 only shows one head and one disk surface.

The dynamic performance of HDD 110 is a major mechanical factor for achieving higher data capacity as well as for manipulating this data faster. The quantity of data tracks 136 recorded on disk surfaces 135 is determined partly by how well a particular magnetic head 156 and a particular desired data track 136 can be positioned to each other and made to follow each other in a stable and controlled manner.

There are many factors that will influence the ability of HDD 110 to perform the function of positioning a particular magnetic head 156, and following a particular data track 136 with the particular magnetic head 156. In general, these factors can be put into two categories; those factors that influence the motion of magnetic heads 156; and those factors that influence the motion of data tracks 136. Undesirable motions can come about through unwanted vibration and undesirable tolerances of components. Herein, attention is given to construction of sliders 130 and features that contribute to passive damping both in and out of contact with disk surfaces 135. In one embodiment of the invention, a combination clamp seal and counter balance is used to simultaneously balance the motor-hub assembly 130 and protect the motor-hub assembly 130 from contamination.

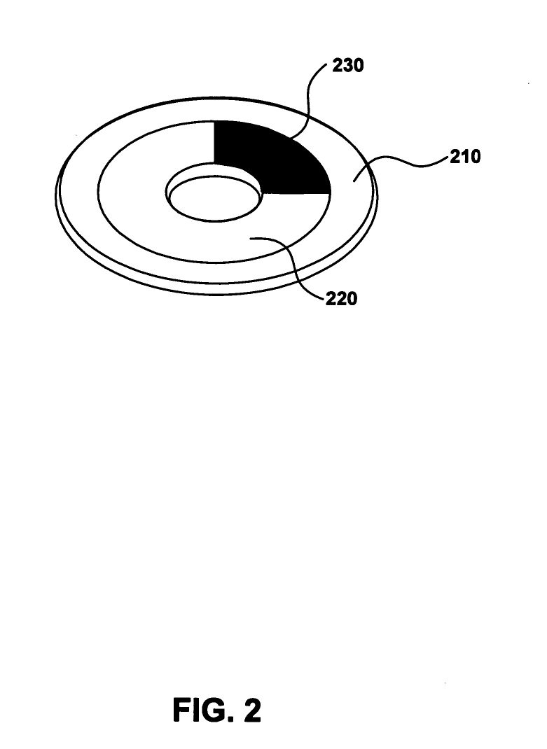

FIG. 2 is an illustration of an exemplary disk clamp seal 220 comprising a counterweight balance 230 in accordance with embodiments of the present invention. The disk clamp 210 attaches the disk 135 of FIG. 1 to the hub assembly 130 of FIG. 1. Conventionally, fasteners (not shown), e.g., screws, attach the disk clamp 210 to the hub assembly 130 of FIG. 1. A disk clamp seal 220 prevents contamination from the disk clamp 210 from reaching the disk surface. In one embodiment of the invention, the clamp seal 220 prevents metal shavings from the fasteners holding the disk clamp 210 to the hub assembly 130 of FIG. 1 from contaminating other parts of the disk drive assembly 110 of FIG. 1. In one embodiment of the invention, the clamp seal 220 comprises a counterbalance weight 230 for balancing the rotating assembly of the disk drive.

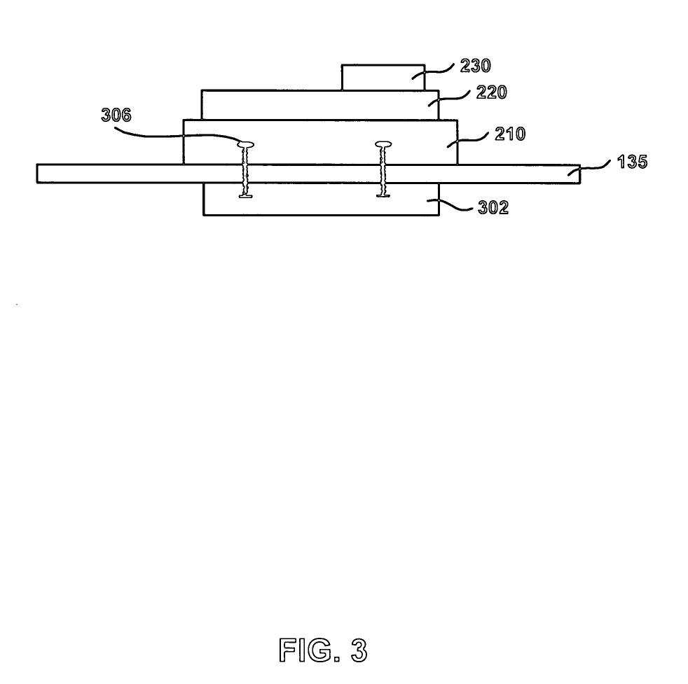

FIG. 3 is a side view illustration of an exemplary disk drive stack assembly comprising a clamp seal 220 with an integrated counterbalance weight 230 in accordance with embodiments of the present invention. As stated above, the disk clamp 210 fastens the disk 135 to the hub assembly 302. In one embodiment of the invention fasteners 306 attach the disk clamp 210 to the hub 302. The clamp seal 220 prevents contamination (e.g., debris from the fasteners 306) from reaching other parts of the disk drive assembly. The counterbalance weight 230 balances the rotating assembly of the disk drive. In one embodiment of the invention, the counter balance is integral to the clamp seal 220 and is coupled to the disk clamp 210 simultaneously. Embodiments of the present invention eliminate the need of separate processing steps for sealing the hub assembly and balancing the hub assembly. The integrated clamp seal/counterbalance weight of the present invention greatly reduces the processing of conventional disk drive assembly.

In one embodiment of the invention, the counterweight balance and clamp seal is a laminate structure comprising a plurality of layers. In one embodiment of the invention, the counterweight comprises metal. In another embodiment of the invention, the counterweight comprises fibrous material such as paper. In one embodiment of the invention, the counterweight comprises an arc shape. For example, the counterweight is a portion of a ring shape.

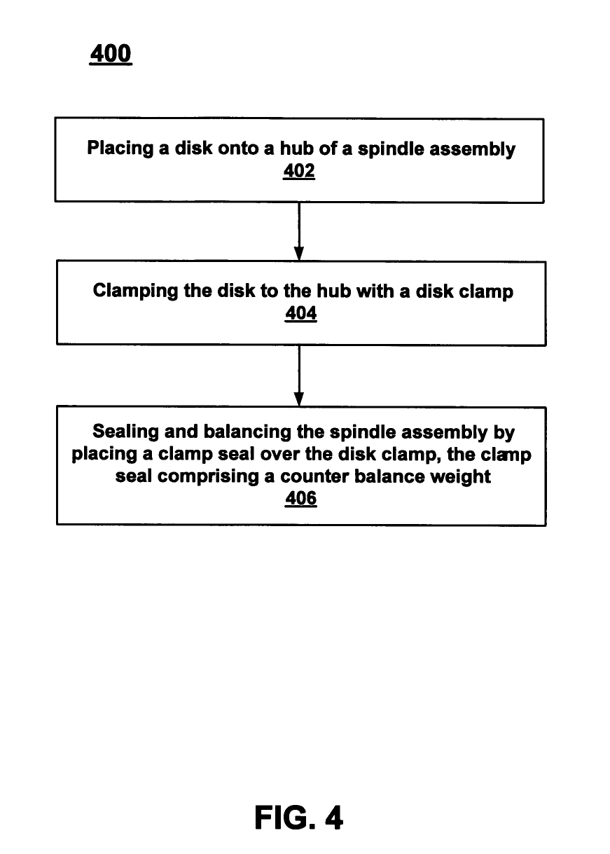

FIG. 4 is a flow diagram of an exemplary method 400 for manufacture of a disk drive comprising a clamp seal with an integrated counterbalance in accordance with embodiments of the present invention.

At step 402, method 400 includes placing a disk onto a hub of a spindle assembly. At step 404, method 400 includes clamping the disk to the hub with a disk clamp. In one embodiment of the invention, the disk clamp is coupled to the hub with fasteners (e.g., screws). However, it is appreciated that embodiments of the present invention are suitable to be used with a variety of disk drive assemblies, including various different disk drive clamps and spindle/hub assemblies.

At step 406, method 400 includes sealing and balancing the spindle assembly by placing a clamp seal over the disk clamp wherein the disk clamp seal comprises a counterbalance weight coupled thereto. In one embodiment of the invention, the counterbalance weight is integral with the clamp seal. In another embodiment of the invention, the counterbalance weight is one of a plurality of laminate layers of the clamp seal.

In one embodiment of the invention, a clamp seal is positioned over the disk clamp and the spindle assembly is rotated. During rotation, an imbalance of the rotating assembly is determined. Once the imbalance is determined, an appropriate counter balance weight and location is determined. Then the appropriate counterbalance can be coupled to the clamp seal at the proper location. In one embodiment of the invention, the counterbalance weight is coupled to the clamp seal by an adhesive.

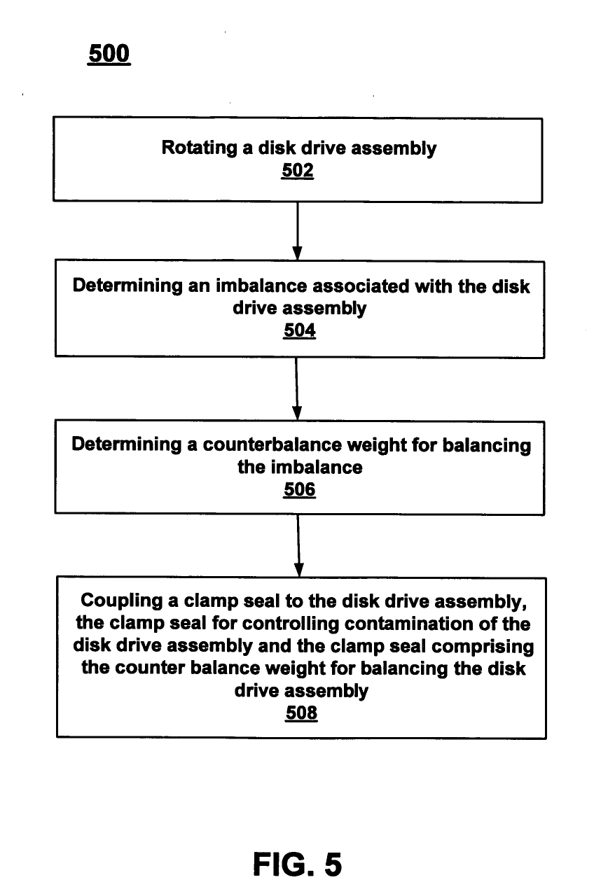

FIG. 5 is a flow diagram of an exemplary method 500 for manufacture of a disk drive including rotating a disk drive assembly to determine an imbalance and an associated counterbalance in accordance with embodiments of the present invention.

At step 502, method 500 includes rotating a disk drive assembly. In one embodiment of the invention, the disk drive assembly comprises the spindle, spindle hub, hard disk and disk clamp. However, it is appreciated that the disk drive assembly can include any parts of a hard disk drive in accordance with the present invention.

At step 504, method 500 includes determining an imbalance associated with the disk drive assembly. In one embodiment of the invention, the imbalance includes a weight and location.

At step 506, method 500 includes determining a counterbalance weight for balancing the imbalance determined in step 504. In one embodiment of the invention, dimensions of a counterbalance weight are determined. For example, in one embodiment of the invention, the counterbalance weight is a portion of a ring shape similar to the clamp seal. In this embodiment of the invention, an arc angle of the counterbalance weight is determined. An example of this embodiment is illustrated in FIG. 2 wherein the counterbalance weight 230 is an arc.

At step 508, method 500 includes coupling a clamp seal to the disk drive assembly wherein the clamp seal controls contamination of the disk drive assembly and the clamp seal comprises the counterbalance weight determined in step 506.

In one embodiment of the invention, the clamp seal with integrated counterbalance weight is intended to be used to balance rotating assemblies of disk drives in the 2.5 inch diameter and smaller format. However, it is appreciated that embodiments of the present invention can be used on any size hard disk drive assembly.

Embodiments of the present invention, a system and method for integrated spindle balance and contamination control have been described. While the present invention has been described in particular embodiments, it should be appreciated that the present invention should not be construed as limited by such embodiments, but rather construed according to the following Claims.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A disk drive comprising:
a spindle for rotating a disk, said spindle comprising a hub;
a disk clamp for clamping said disk to said hub; and
a clamp seal coupled to said disk clamp for sealing said disk clamp from contamination wherein said clamp seal comprises a counter balance weight for balancing said rotation of said disk.

2. The disk drive as described in claim 1 wherein said clamp seal is a laminate comprising a plurality of layers.

3. The disk drive as described in claim 2 wherein one of said plurality of layers comprises metal.

4. The disk drive as described in claim 1 wherein said clamp seal and said counter balance weight are coupled to said disk clamp simultaneously.

5. The disk drive as described in claim 1 wherein said clamp seal is coupled to said disk clamp by an adhesive.

6. The disk drive as described in claim 1 wherein said clamp seal comprises an arc shape.

7. A method for manufacturing a disk drive comprising:
placing a disk onto a hub of a spindle assembly;
clamping said disk to said hub with a disk clamp; and
sealing and balancing said spindle assembly by placing a clamp seal over said disk clamp, said clamp seal comprising a counter balance weight.

8. The method as described in claim 7 wherein said clamp seal is a laminate comprising a plurality of layers.

9. The method as described in claim 8 wherein one of said plurality of layers comprises metal.

10. The method as described in claim 7 wherein said clamp seal and said counter balance weight are coupled to said disk clamp simultaneously.

11. The method as described in claim 7 wherein said clamp seal is coupled to said disk clamp by an adhesive.

12. The method as described in claim 7 wherein said clamp seal comprises an arc shape.

13. The method as described in claim 7 wherein prior to sealing and balancing said spindle assembly, said method further comprises:
rotating said spindle assembly, said disk and said disk clamp.

14. The method as described in claim 13 further comprising:
determining an imbalance of one or more of said spindle assembly, said disk and said disk clamp.

15. The method as described in claim 14 further comprising:
determining dimensions of said counter balance weight based on said imbalance.

16. A method for balancing a disk drive comprising:
rotating a disk drive assembly;
determining an imbalance associated with said disk drive assembly;
determining a counterbalance weight for balancing said imbalance; and
coupling a clamp seal to said disk drive assembly, said clamp seal for controlling contamination of said disk drive assembly and said clamp seal comprising said counter balance weight for balancing said disk drive assembly.

17. The method as described in claim 16 wherein said clamp seal is a laminate comprising a plurality of layers.

18. The method as described in claim 17 wherein one of said plurality of layers comprises metal.

19. The method as described in claim 16 wherein said clamp seal and said counter balance weight are coupled to said disk clamp simultaneously.

20. The method as described in claim 16 wherein said clamp seal is coupled to said disk clamp by an adhesive.

21. The method as described in claim 16 wherein said clamp seal comprises an arc shape.
